(19) United States
(12) Patent Application Publication
(10) Pub. No.: US 2026/0323110 A1
(43) Pub. Date: Oct. 15, 2026

(54) SYSTEM AND METHOD FOR PRESENTING AN ELECTRONIC PROGRAM GUIDE ON A DUAL SCREEN TELEVISION

(71) Applicant: Telly, Inc., Sherman Oaks, CA (US)

(72) Inventors: Ilya Pozin, Los Angeles, CA (US); Sascha Prueter, Daellikon (ZH); Benjamin Hickman, Los Angeles, CA (US); Stephen Shannon, Los Angeles, CA (US)

(21) Appl. No.: 19/483,208

(22) PCT Filed: May 9, 2024
(86) PCT No.: PCT/US2024/028563

§ 371 Date: Nov. 10, 2025

Related U.S. Application Data
(60) Provisional application No. 63/465,204, filed on May 9, 2023.

(51) Int. Cl. H04N 21/41; H04N 21/422; H04N 21/4363; H04N 21/482

(52) U.S. Cl. CPC H04N 21/4122; H04N 21/42204; H04N 21/43635; H04N 21/482

(57) ABSTRACT

A television system comprising a housing, a primary screen in the housing, the primary screen configured to display first content, the first content including linear digital content, a secondary screen in the housing, the secondary screen configured to display second content, the secondary screen having a height less than the primary screen, an audio source disposed in the housing, the audio source configured to output audio associated with at least one of the first content and the second content, a user input device configured to receive one or more user commands, and a processor configured to display the first content on the primary screen and an electronic programming guide on the secondary screen.

### CROSS-REFERENCE TO RELATED APPLICATIONS

This application claims the benefit of U.S. Provisional Patent Application No. 63/465,204 filed May 9, 2023 entitled “System And Method For Presenting An Electronic Program Guide On A Dual Screen Television”, which is incorporated by reference herein in its entirety.

### FIELD OF THE INVENTION

The present application relates to television displays and, more particularly, to a television that integrates two display portions in a vertical stack that features the ability to present electronic program guide information from a variety of services in one screen while the main program content is presented in the other screen.

### BACKGROUND OF THE INVENTION

The proliferation of streaming video applications and the availability of video content online, has led to increased demands being placed on televisions to display traditional linear television content and make additional streaming or internet-based content available to television users.

Limitations of existing televisions, however, lead to clumsy control and screen overlays designed to present electronic program guides or other interactive content over a program on the screen. These screen overlays may interfere with viewing a currently displayed television program.

Existing televisions generally have incorporated a single display screen to present television content to users. Some televisions have allowed picture in picture for watching programs while navigating menus and split screen functionality that allows users to watch more than one television program at a time. However, this functionality has generally been limited to displaying programs and menus on the same screen at a reduced size. Televisions have also been arranged in arrays to allow single television sets to be physically placed in an array to each display part of a larger picture that is captured in the entire array.

There is a need for a television that allows the presentation of a television program or streaming content, in addition to an electronic program guide and other content, in such a manner that the additional content, features and functionality do not interfere with the television program. There is a further need for a television that provides access to application programs and application program functionality that does not detract from a program or other content on the main screen. There is a further need for a television that maximizes the ability to provide electronic program guides from a variety of devices or services in a manner desired by the viewer that does not interfere with the main program, while at the same time allowing additional features, content and interactive functionality without the shortcomings of conventional televisions.

### SUMMARY OF THE INVENTION

Embodiments of the present disclosure are directed to a television system having a housing, a primary screen in the housing, the primary screen configured to display first content, the first content including linear digital content, a secondary screen in the housing, the secondary screen configured to display second content, the secondary screen having a height less than the primary screen, an audio source disposed in the housing, the audio source configured to output audio associated with at least one of the first content and the second content, a user input device configured to receive one or more user commands, and a processor. The processor is configured to display, on the primary screen, the first content and while displaying the first content on the primary screen receive an electronic program guide (EPG) initiation command from a user input device, the EPG initiation command being an indication of a user command from the user input device to access the EPG, in response to receiving the EPG initiation command, display, on the secondary screen, an electronic program guide, receive a navigational programming command from the user input device, and in response, cause a different portion of the EPG to display on the secondary screen to assist with user navigation of the EPG, receive a programming selection command from the user input device on the EPG indicating a user's desire to view content from a particular program, and in response to receiving the programming selection command, cause the primary screen to display new content based on the programming selection while continuing to concurrently display the electronic program guide on the secondary screen.

In some embodiments, the processor is further configured to determine a source of the electronic program guide and determine a format of the electronic program guide based on the origination source.

In some embodiments, the user input device is a remote control and the remote control wirelessly communicates with the television system.

In some embodiments, a source of the electronic program guide is a device coupled to the television system through an HDMI port. A source of the electronic program guide provides programming data in a format of one of an ATSC or PAL tuner. A source of the electronic program guide is a service that generates electronic program guide information available at a server accessible over the Internet.

In some embodiments, the electronic program guide corresponds to content for a service or device different from a source of content currently being displayed on the primary screen.

In some embodiments, the first content is dynamic content and the second content is static content requiring the navigational programming command to change the display.

In some embodiments, the primary screen, the audio source, and the secondary screen are arranged in a vertically stacked arrangement such that a central axis of the primary screen bifurcates the audio source and the secondary screen.

In some embodiments, a width of the primary screen is substantially the same as a width of the secondary screen.

In some embodiments, the navigational programming command does not disrupt displaying of the first content on the primary screen.

Another embodiment of the present disclosure is directed to a method of operating a television system, the method including displaying, on a primary screen, the first content, the primary screen being disposed within a housing and the first content including linear digital content and while displaying the first content on the primary screen, receiving an electronic program guide (EPG) initiation command from a user input device, the EPG initiation command being an indication of a user command from the user input device to access the electronic program guide, in response to receiving the EPG initiation command, displaying, on a secondary screen coupled to the primary screen, an electronic program guide, the secondary screen being disposed within the housing and having a height less than the primary screen, receiving a navigational programming command from the user input device, and in response to receiving the navigational programming command, causing a different portion of the EPG to display on the secondary screen to assist with user navigation of the EPG. The method further includes receiving a programming selection command from the user input device on the EPG indicating a user's desire to view content from a particular program and in response to receiving the programming selection command, causing the primary screen to display new content based on the programming selection while continuing to concurrently display the electronic program guide on the secondary screen.

In some embodiments, a source of the electronic program guide is a device coupled to the television through an HDMI port. A source of the electronic program guide provides programming data in a format of one of an ATSC or PAL tuner. A source of the electronic program guide is a service that generates electronic program guide information available at a server accessible over the Internet.

In some embodiments, the electronic program guide corresponds to content for a service or device different from a source of content currently being presented on the primary screen.

In some embodiments, the first content is dynamic content and the second content is static content requiring the navigational programming command.

In some embodiments, the primary screen, the audio source, and the secondary screen are arranged in a vertically stacked arrangement such that a central axis of the primary screen bifurcates the audio source and the secondary screen.

In some embodiments, a width of the primary screen is substantially the same as a width of the secondary screen.

In some embodiments, the navigational programming command does not disrupt displaying of the first content on the primary screen.

### BRIEF DESCRIPTION OF THE FIGURES

The above described features and advantages of the present disclosure will be more fully appreciated with reference to the following figures.

FIG. 1A depicts a television system that includes a primary screen, a secondary screen, and an audio source according to embodiments of the present disclosure.

FIG. 1B depicts the television system of FIG. 1A with an electronic program guide displayed on the secondary screen according to embodiments of the present disclosure.

FIG. 2 depicts a functional block diagram of the television system of FIG. 1A that integrates an electronic program guide on the primary screen and/or the secondary screen according to embodiments of the present disclosure.

FIGS. 3A-3D depict an exemplary use of an electronic program guide to display new content the primary screen of the television system of FIG. 1A according to embodiments of the present disclosure.

FIG. 4 depicts a functional block diagram of an electronic program guide system that determines configuration information to facilitate selecting and presenting an electronic program guide on a secondary screen of the television system of FIG. 1A according to embodiments of the present disclosure.

FIG. 5 depicts a method of displaying an electronic program guide using the television system of FIG. 1A according to embodiments of the present disclosure.

### DETAILED DESCRIPTION

One or more embodiments of the present disclosure are directed to a television system having two screens that are integrally contained in a housing. One of the screens (e.g., the primary screen) is the main screen and the other screen (e.g., the secondary screen) is a smaller screen that may be used to provide an electronic program guide according to user configurations, along with widgets and advertising.

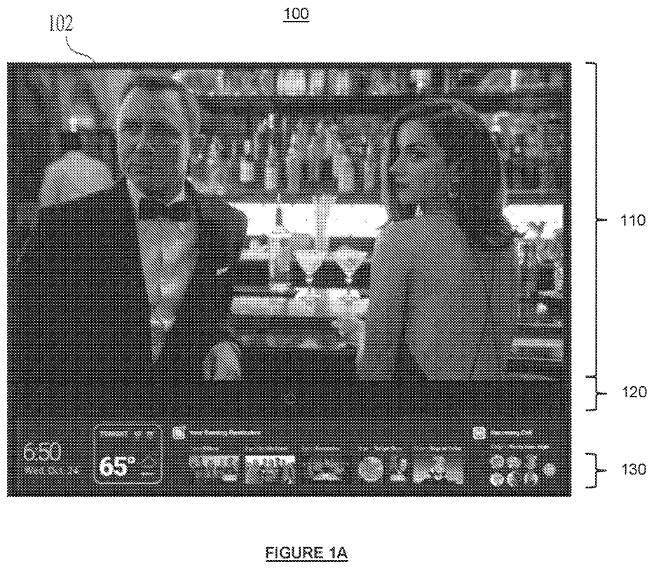

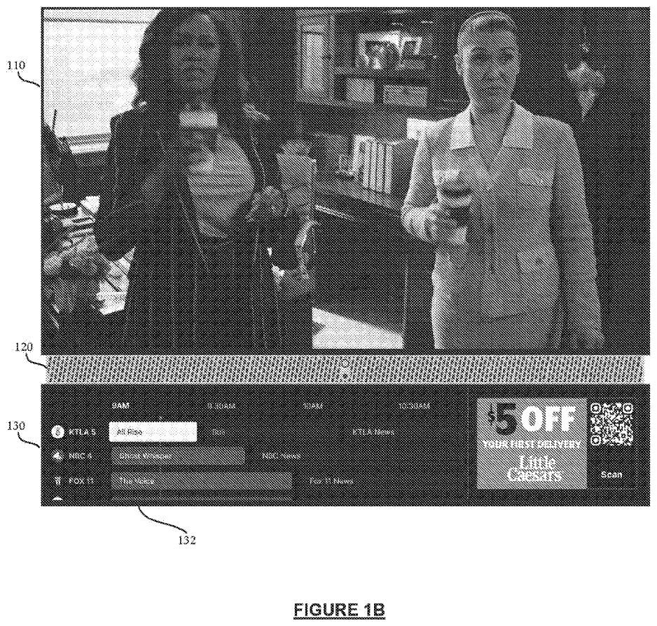

FIG. 1A depict a television system 100 that integrates two distinct screens and concurrent functionality according to one or more embodiments of the present disclosure. The television system 100 includes an overall housing 102, a primary screen 110, and a secondary screen 130. The primary screen 110 and the secondary screen 130 may be separated by an audio source 120. The audio source 120 may be a sound bar or speaker. In some embodiments, the audio source 120 is disposed between the primary screen 110 and the secondary screen 130.

In some embodiments, the primary screen 110 and the secondary screen 130 may be separated by a physical divider or placed adjacent to one another. The secondary screen 130 may be portioned into areas or elements where the screen output is determined by widget programs (e.g., EPG widget 131, widgets 134, 135, 136), that present information, interactions, or other information to users. For example, a user may select electronic programming guide (EPG) widget 131 to access an electronic programming guide (e.g., EPG 132) or may select widget 134 to access a specific application for viewing content on the primary screen 110.

The primary screen 110 and the secondary screen 130 may be vertically stacked. For example, the primary screen 110 may be vertically disposed above the secondary screen 130. In some embodiments, the primary screen 110 and the secondary screen 130 may be vertically stacked such that a central axis of the primary screen 110 also extends along the central axis of the secondary screen 130. In other words, the central axis of the primary screen 110 may bifurcate the secondary screen 130. In some embodiments, the audio source 120 may be disposed between the primary screen 110 and the secondary screen 130 such that the central axis of the primary screen 110 bifurcates the audio source 120 and the secondary screen 130.

According to an embodiment of the invention, the secondary screen 130 is approximately ¼ to ⅓ the height of the primary screen 110, which preferably has an aspect ratio of 16:9. This allows a television viewer or user to watch a standard 16:9 TV screen (e.g., the primary screen 110) while simultaneously watching a smaller, lower screen (e.g., the secondary screen 130) for multitasking. In some embodiments, the secondary screen 130 has a width substantially the same as the primary screen 110, but a height that is a percentage of the primary screen 110. For example, the secondary screen 130 may have a height that is 10% to 90%, 20% to 80%, 30% to 70%, or 40% to 60% the height of the primary screen 110. In some embodiments, the audio source 120 has a width less than the width of the primary screen 110 and secondary screen 130. In alternative embodiments, the audio source 120 has a width greater than the width of the primary screen 110 and secondary screen 130.

Additionally, the secondary screen 130 can be on while leaving the primary screen 110 off for media consumption including text, graphics, advertising, video, and audio. This arrangement facilitates providing a full range of interactive content, control and features to users via the provision of applications that may control either screen or both screens simultaneously. Such applications enable the linking of content, control and features between the two screens and ancillary devices such a sound bar, which may also be integrated into the television system 100.

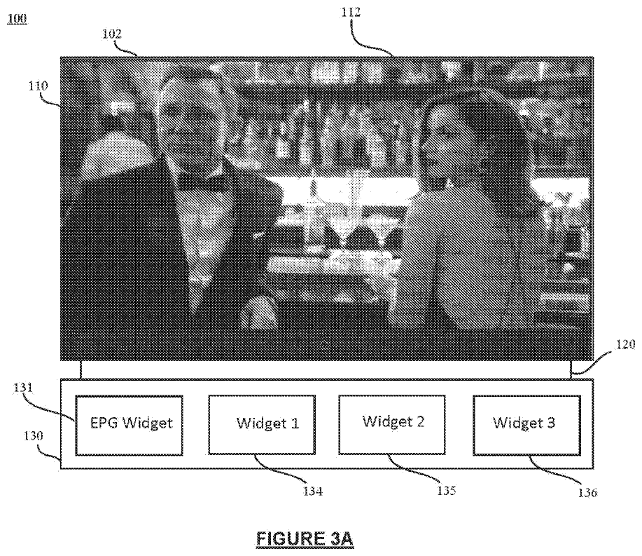

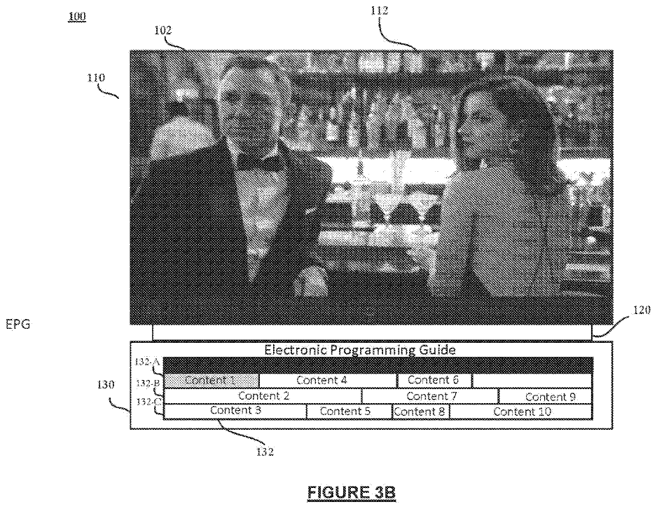

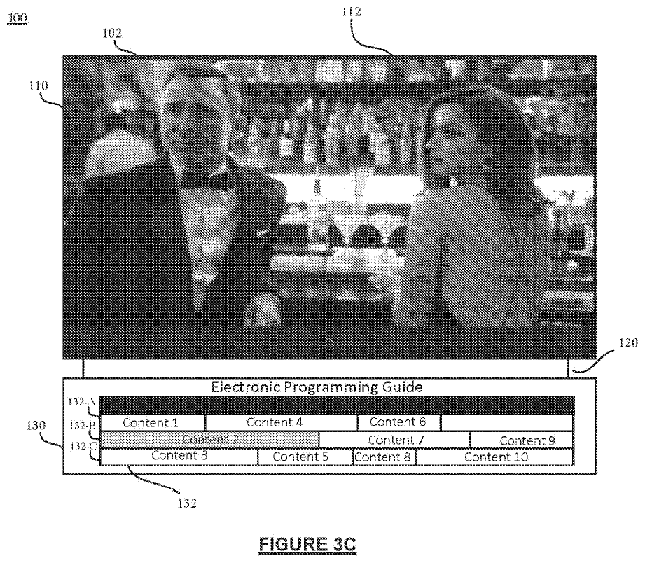

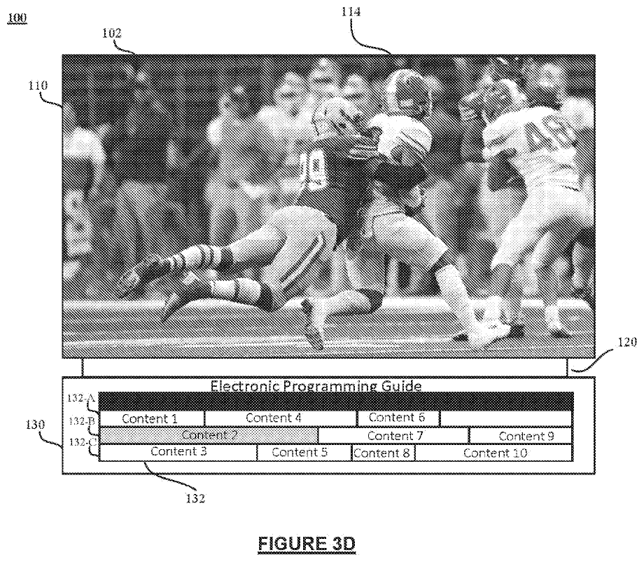

The primary screen 110 may be configured to display first content (e.g., content 112) and the secondary screen 130 may be configured to display second content (e.g., EPG 132 shown in FIG. 1B). The first content may be linear digital content, which may be dynamic content. The second content may be different than the first content and may include programming content (e.g., electronic programming guide 132), advertising content, navigation content, or virtual communication content. In some embodiments, a user interacts with the second content on the secondary screen 130 to change the first content on the primary screen 110 to new content (e.g., from content 112 to content 114 as shown in FIGS. 3C-3D).

According to some embodiments, the integrated television screens (e.g., the primary screen 110 and the secondary screen 130) may comprise separate television panels integrated into a single television, with or without a soundbar. In other embodiments, for example, a single 4:3 panel may be configured with a physical screen divider and hardware and software provisioning to divide the television system into two separate integrated screens. According to one embodiment, HDMI ports may deliver video to the primary screen 110 only. In other embodiments, the HDMI ports may deliver video to the primary screen 110 and the secondary screen 130.

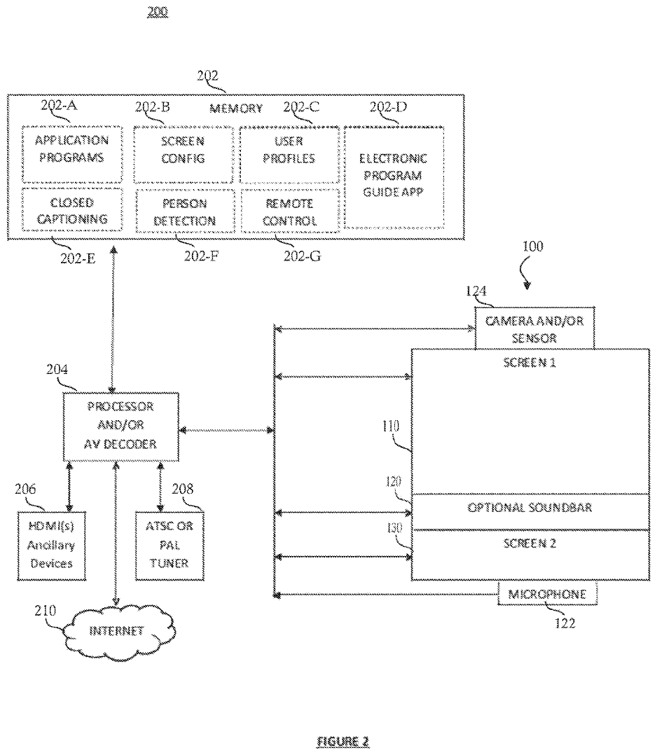

FIG. 2 depicts a functional block diagram of the television 100 according to embodiments of the present disclosure. As illustrated in FIG. 2, the television system 100 may include a processor 204 coupled with a memory 202, HDMI ports 206, an ATSC or PAL tuner 208, a camera and/or sensor, a microphone 122, speakers or an optional soundbar (e.g., the audio source 120), the Internet 210, and two distinct screens (e.g., the primary screen 110 and the secondary screen 130), as described above. The memory 202 may store programs that include program instructions that are executed by the processor 204 to enable the various functionalities of the television. The memory 202 may include, for example, application programs 202-A, an electronic program guide application program 202-D for accessing EPG 132, a screen configuration program 202-B, a person detection program 202-F, a user profile program 202-C, and a remote control program 202-G, among others.

The HDMI ports 206 enable A/V devices to be connected to the television system 100, including DVD players, DVRs, sound bars, streaming boxes, A/V Receivers, gaming consoles and other equipment. ATSC or PAL tuners 208 may be incorporated into the television system 100 to allow the television system 100 to receive over the air or certain cable broadcasts and present them on the primary screen 110, or on the secondary screen 130.

A microphone 122 may be included in the television system 100, such as within the housing 102 to allow the user to provide spoken commands to the television system 100, to allow for video conferencing, and to allow other audio visual applications. A camera 124 may also be provided to facilitate functionality such as to permit video conferencing and for gesture and motion recognition and a sensor may also be provided to facilitate functionality such as determining the number of viewers of the television system 100 among other features. The screens (e.g., primary screen 110 and secondary screen 130) are distinct and render images corresponding to content from the HDMI ports 206, from the tuners 208, from the Internet 210, streaming or other interconnected devices. In addition, the content of the screens may be determined by application programs or any of the other programs stored in memory 202 and executed by the processor 204. The speakers and/or optional soundbar 120 are used to provide audio output corresponding to content displayed on the screens or enabled through the application programs or other programs provided on the television. The television system 100 may also incorporate a RF receive or RI port for receiving signals from a remote control used to control the television system 100.

The processor 204 may be a single microprocessor, multiple processors, or a processor and a co-processor. In one embodiment, a primary microprocessor may be used to render and operate the user interface while a second processor may be used to decode video, for example H.264 format outputting a signal via HDMI. The processor(s) 204 may support all functionality needed to operate the display screens of the television, and synchronize images with audio output, including rendering, video decoding, audio decoding, audio visual synchronization control, motion estimation and motion compensation, picture quality, time stamp normalization, frame rate control, and over the air updates. In addition, the processor(s) 204 executes program instructions from memory to enable applications to be presented on one or both screens of the television, and to permit use of the speakers, microphone, cameras, internet connection, remote control, and two-way communication with ancillary devices connected to the television, such as content streaming hardware.

According to an embodiment of the present invention, the processor 204 may be an application processor designed specifically for smart display applications such as the A311D2 processor, and may include, for example, CPU/GPU subsystems, video codecs, graphics subsystems, video engines, video/graphics output pipelines, HDMI receiver ports, demultiplexers for broadcast and streaming video, digital signal processors (DSPs) for processing audio, peripheral interfaces such as for Ethernet, USB, SDIO 3.0, eMMC 5.1, SDIO/SD card controller, UART, I2C, high-speed SPI PWMs and an RI blaster. The processor may be distributed or a system on a chip and may interface with additional memory and components of the television.

The processor 204 may be configured to display first content (e.g., content 112) on the primary screen 110. The first content may be content that the user desires to watch while the user interacts with second content (e.g., EPG 132) being displayed on the secondary screen 130. In some embodiments, while displaying the first content on the primary screen 110, the processor receives an electronic program guide (EPG) initiation command from a user input device. The user input device may be a remote control, mobile device, desktop computer, a wired device coupled to the television system 100, or a wireless device configured to wirelessly communicate with the television system 100. The EPG initiation command may be an indication of a user command transmitted by the user input device of the user's desire and intention to access the EPG.

The processor 204, in response to receiving the EPG initiation command, may display on the secondary screen 130 an electronic program guide (EPG) 132. The processor 204 may receive, such as from the user input device, a navigational programming command. The navigational programming command may allow a user to navigate the EPG 132 to, for example, access different content or applications. In response to receiving the navigational programming command, the processor 204 may cause a different portion of the EPG 132 to display on the secondary screen 130 to assist with user navigation of the EPG.

In some embodiments, the processor 204 receives a programming selection command from the user input device on the EPG 132. The programming selection command may indicate a user's desire to view content from a particular program. For example, the EPG 132 may present information that a particular program or content is available for viewing. The user using the user input device may make a selection of the particular program or content. In response to receiving the programming selection command, the processor may cause the primary screen 110 to display new content based on the programming selection while continuing to concurrently display the electronic program guide on the secondary screen 130.

Referring back to FIG. 1A, in some embodiments, a user may view content on the primary screen 110, while using the secondary screen 130 to access an EPG 132 using some or all of the system components shown in FIG. 2. The EPG 132 may be displayed on the secondary screen 130, without overlaying or obstructing the content of the primary screen 110. For example, as shown in FIG. 1A, the primary screen 110 may display first content and the user using a user input device may interact with the second content (e.g., the EPG 132) on the secondary screen 130 such that the second content does not obstruct, overlay, or otherwise disrupt viewing of the first content on the primary screen 110. Upon a user's selection of content, program, or application on the secondary screen 130 (e.g., by interacting with the second content) the primary screen 110 changes to display the new content, program, or application. A user may interact with the second content on the secondary screen 130 to change or adjust content on the primary screen 110, without the second content being displayed on the primary screen 110.

FIGS. 3A-3D illustrate activation and navigation of the EPG 132 displayed on the secondary screen 130. Referring to FIG. 3A, the television system 100 may display first content, such as first content 112, on the primary screen 110 and one or more applications or widgets, such as EPG widget 131 or widgets 134, 135, 136. A user, using a user input device, may select a desired application or widget. For example, a user may provide an EPG initiation command to select EPG widget 131 and access electronic programming guide (EPG) 132.

In some embodiments, the television system 100 (e.g., via a processor disposed within housing 102) receives a command, such as an EPG initiation command, to boot-up or load the EPG 132 on secondary screen 130 based on the selection of EPG widget 131. For example, a user may use user input device such as a remote control to transmit the EPG initiation command to access the EPG 132 on secondary screen 130. In some embodiments, the EPG 132 displays on a portion of secondary screen 130. As shown in the FIG. 3B, selecting EPG widget 131 results in the secondary screen 130 displaying EPG 132 to provide a user access to EGP 132 while still displaying the first content 112 on the primary screen 110.

As shown in FIG. 3B, EPG 132 may include a plurality of content elements (e.g., content elements 132-A, 132-B, 132-C . . . 132-N (not shown)) for a user to navigate through to select a desired content for viewing. For example, a user may navigate to content 1 by selecting content element 132-A of EPG 132, via a user input device.

A user may navigate to another content on EPG 132, such as content 2, by navigating to content element 132-B. Navigation from Content 1 to Content 2 is shown in the transition from FIG. 3B to FIG. 3C and represented by the highlighting of Content 1 in FIG. 3B and highlighting Content 2 in FIG. 3C. A user may provide one or more navigational programming commands to interact with and navigate through EPG 132 via user input device.

In some embodiments, each content element 132-A, 132-B, 132-C, 132-N represents a different content (e.g., TV show, movie, sporting event), application, or program. As shown in FIGS. 3A-3C, navigating EPG 132 results in the secondary screen 130 refreshing and updating, while the primary screen 110 continues to display first content 112. In some embodiments, the EPG 132 is displayed on the secondary screen 130 and navigation between each content element 132 is also displayed on the secondary screen 130. In response to navigation between content elements 132, content from the secondary screen 130 or the EPG 132 of the secondary screen 130 do not overlay or obstruct the first content 112 being displayed on the primary screen 110.

With continued reference to FIG. 3C, the user may provide a programming selection command, using the user input device, to select content element 132-B. Upon processor 204 of the television system 100 receiving the programming selection command indicating the user's selection of content element 132-B (. e.g., content 2), processor 204 may cause the primary screen 110 to display new content 114 corresponding to content 2 as shown in FIG. 3D. For example, in response to receiving the programming selection command, the primary screen 110 may no longer display first content 112, but may now display new content 114. New content 114 may be content 2 associated with the user's selection of content element 132-B on the EPG 132. In some embodiments, upon new content 114 being displayed on the primary screen 110, the secondary screen 110 may continue to display the EPG 132 allowing a user to further interact with the EPG 132 on the secondary screen 130 while viewing the new content 114 on the primary screen. In some embodiments, the first content 112 of the primary screen 110 is not obstructed or overlayed with additional content or new content until the user provides a programming selection commend selecting a desired content element 132-N.

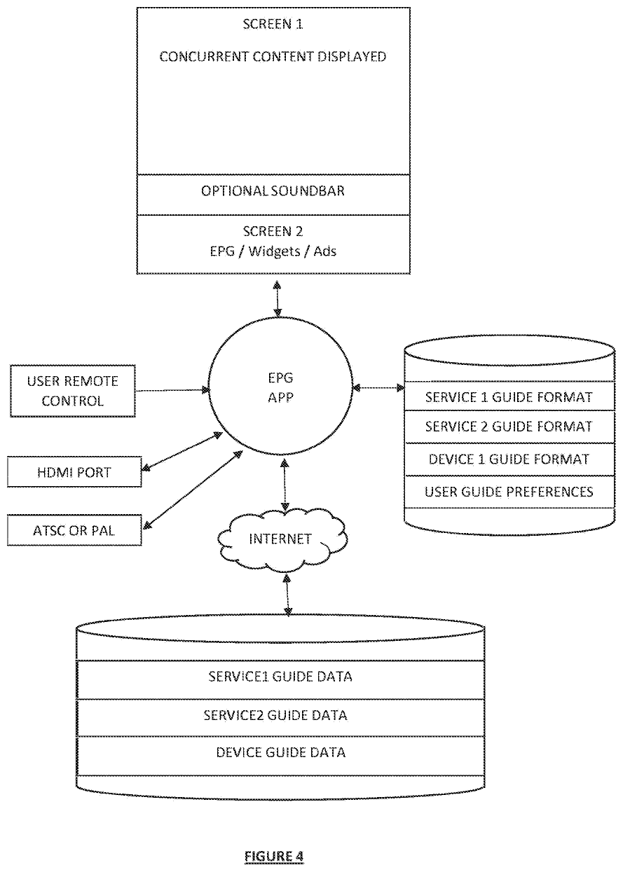

FIG. 4 depicts a functional block diagram of an electronic program guide application program that selects and displays an electronic program guide (e.g., EPG 132) on the secondary screen 130 of the television system 100. Referring to FIG. 4, a remote control is used to interact with the television system 100 to determine content displayed in the primary screen 110 and separate content on the secondary screen 130, including widgets and electronic program guide information. The electronic program guide application includes program instructions resident in memory that interact with data in memory related to the electronic program guide configurations for services, devices and television users. The services and devices may have different formats that need to be adjusted or translated to be presented on the secondary screen 130. Formatting may include changing the size, aspect ratios or fonts of the electronic program guide. Formatting also may include translating between MPEG and other formats to ones that the processor may present on the secondary screen 130. The user may also specify preferences for electronic guide information, including size, and whether it is an overlay or not, among other things. The electronic program guide information itself may come from an HDMI port for an HDMI connected device and/or service. Alternatively, the electronic program guide information may come from an over the air source via, for example, an ATSC or PAL tuner. The source of the electronic program guide information may also come from a service at a server on the Internet. Such Internet sources may be specified by URL, IP address, or in any convenient manner. The remote control of the television or microphone may be used to select the electronic program guide for viewing. Once selected, the EPG application (e.g., EPG 132) may configure the media processor to format and send electronic program guide information for display on the secondary screen 130, consistent with the applicable configuration settings and any relevant user preferences. Users may select content for display on the main screen from the secondary screen 130, causing the selected content to be displayed on the main screen.

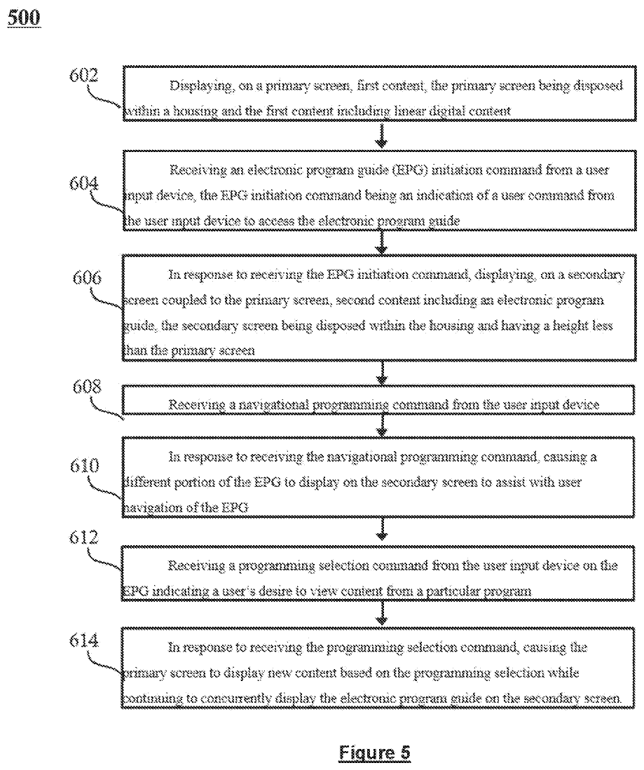

FIG. 5 is a flowchart illustrating an exemplary method 500 for operating a television system, such as the television system shown in FIGS. 1A and 2.

At operation 602, a processor (e.g., processor 204) may display first content on the primary screen 110. For example, as shown in FIG. 3A, the primary screen 110 may display the first content 112. The primary screen 110 may be disposed within a housing 102 and the first content 112 may be linear digital content.

At operation 604, while displaying the first content on the primary screen 110, the processor 204 may receive an electronic program guide (EPG) initiation command from a user input device, such as a remote control. The EPG initiation command may be an indication of a user command from the user input device to access the EPG 132. For example, a user may use the user input device to select EPG widget 131 to transmit the EPG initiation command to the processor 204 to allow the user to access the EPG 132. With reference to FIGS. 3A-3B, a user may interact with EPG widget 131 shown in FIG. 3A and transmit the EPG initiation command to cause the secondary display 130 to display EPG 132 shown in FIG. 3B.

At operation 606, in response to receiving the EPG initiation command, the processor 204 may display the EPG 132 on the secondary screen 130, as shown in FIG. 3B. In some embodiments, the secondary screen 130 is different than the primary screen 110. For example, the secondary screen 130 may be vertically coupled to the primary screen 110 such that the primary screen 110 and the secondary screen 130 are vertically arranged in series. In some embodiments, an audio source (e.g., audio source 120) is disposed between the primary screen 110 and the secondary screen 130. The secondary screen 130 may be disposed in the housing and may have a height less than the height of the primary screen 110. In some embodiments, because the secondary screen 130 may have different sizes and aspect rations, the processor may adjust the EPG 132 to fit the display of the secondary screen 130 based on configuration settings (e.g., aspect ratio, sharpness, brightness, color saturation) stored in memory of the television system.

At operation 608, the processor may receive navigational programming command from the user input device. The navigational programming command may indicate a desired navigation of the user on the EPG 132. For example, the navigational programming command may transmit from the user input device to the television system 100 (e.g., the processor) when the user interacts with the user input device indicating a desire for the user to navigate to a specific program, content, or application (e.g., content element 132-N) on the EPG 132. As shown in the transition between FIGS. 3B and 3C, a user may provide one or more navigational programming commands to navigate from content element 132-A (e.g., content 1) to content element 132-B (e.g., content 2). For example, as shown in FIG. 3C, a user may navigate to content 2 by interacting with content element 132-B (e.g., via a user input device). A user may navigate to any content desired, such as content element 132-C. In some embodiments, a user uses user input device to navigate to any content element desired. For example, a user may use user input device to navigate from content element 132-A to content element 132-D.

At operation 610, the processor 204, in response to receiving the navigational programming command, may cause a different portion (e.g., a portion showing content element 132-A, 132-B, 132-N) of the EPG 132 to display on the secondary screen 130 to assist with user navigation of the EPG 132. For example, a user may navigate through EPG 132 to cause additional portions to display on secondary screen 130.

At operation 612, the processor 204 may receive a programming selection command from the user input device on the EPG 132. In some embodiments, the programming selection command indicates a user's desire to view content from a particular program, such as specific content on a specific application. As shown in FIG. 3C, a user may provide the programming selection command to select content element 132-B to cause the primary screen 110 to display content 2.

At operation 614, the processor 204, in response to receiving the programming selection command, may cause the primary screen 110 to display new content based on the programming selection while continuing to concurrently display the EPG 132 on the secondary screen 130. As shown in FIG. 3D, in response to receiving the programming selection command to select content element 132-B, content 2 may be selected causing the primary screen 110 to display new content 114 based on the selection of content element 132-B (e.g., content 2). Upon the primary screen 110 displaying new content 113, the secondary screen 130 may continue to display EPG 132 without any overlays or obstruction to new content 114 on the primary screen 110. For example, a user may continue to interact with EPG 132 on the secondary screen 130 without causing obstruction or disruption (e.g., overlays) to new content 114 being displayed on the primary screen 110.

While particular embodiments have been shown and described herein, it will be understood by those having ordinary skill in the art that changes may be made to those embodiments without departing from the spirit and scope of the invention.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIGS. 3 and 6, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 5.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A television system comprising:
a housing;
a primary screen in the housing, the primary screen configured to display first content, the first content including linear digital content;
a secondary screen in the housing, the secondary screen configured to display second content, the secondary screen having a height less than the primary screen;
an audio source disposed in the housing, the audio source configured to output audio associated with at least one of the first content and the second content;
a user input device configured to receive one or more user commands; and
a processor configured to:
display, on the primary screen, the first content;
while displaying the first content on the primary screen:
receive an electronic program guide (EPG) initiation command from a user input device, the EPG initiation command being an indication of a user command from the user input device to access the EPG;
in response to receiving the EPG initiation command, display, on the secondary screen, an electronic program guide;
receive a navigational programming command from the user input device, and in response, cause a different portion of the EPG to display on the secondary screen to assist with user navigation of the EPG;
receive a programming selection command from the user input device on the EPG indicating a user's desire to view content from a particular program; and
in response to receiving the programming selection command, cause the primary screen to display new content based on the programming selection while continuing to concurrently display the electronic program guide on the secondary screen.

2. The television system according to claim 1, wherein the processor is further configured to:
determine a source of the electronic program guide; and
determine a format of the electronic program guide based on the source.

3. The television system according to claim 1 wherein the user input device is a remote control,
wherein the remote control wirelessly communicates with the television system.

4. The television system according to claim 1, wherein a source of the electronic program guide is a device coupled to the television system through an HDMI port.

5. The television system according to claim 1, wherein a source of the electronic program guide provides programming data in a format of one of an ATSC or PAL tuner.

6. The television system according to claim 1, wherein a source of the electronic program guide is a service that generates electronic program guide information available at a server accessible over the Internet.

7. The television system according to claim 1, wherein the electronic program guide corresponds to content for a service or device different from a source of content currently being displayed on the primary screen.

8. The television system according to claim 1, wherein the first content is dynamic content and the second content is static content requiring the navigational programming command to change the display.

9. The television system according to claim 1, wherein the primary screen, the audio source, and the secondary screen are arranged in a vertically stacked arrangement such that a central axis of the primary screen bifurcates the audio source and the secondary screen.

10. The television system according to claim 1, wherein a width of the primary screen is substantially the same as a width of the secondary screen.

11. The television system according to claim 1, wherein the navigational programming command does not disrupt displaying of the first content on the primary screen.

12. A method of operating a television system, the method comprising:
displaying, on a primary screen, first content, the primary screen being disposed within a housing and the first content including linear digital content;
while displaying the first content on the primary screen:
receiving an electronic program guide (EPG) initiation command from a user input device, the EPG initiation command being an indication of a user command from the user input device to access the electronic program guide;
in response to receiving the EPG initiation command, displaying, on a secondary screen coupled to the primary screen, second content including an electronic program guide, the secondary screen being disposed within the housing and having a height less than the primary screen;
receiving a navigational programming command from the user input device; and
in response to receiving the navigational programming command, causing a different portion of the EPG to display on the secondary screen to assist with user navigation of the EPG;
receiving a programming selection command from the user input device on the EPG indicating a user's desire to view content from a particular program; and
in response to receiving the programming selection command, causing the primary screen to display new content based on the programming selection while continuing to concurrently display the electronic program guide on the secondary screen.

13. The method according to claim 12, wherein a source of the electronic program guide is a device coupled to the television through an HDMI port.

14. The method according to claim 12, wherein a source of the electronic program guide provides programming data in a format of one of an ATSC or PAL tuner.

15. The method according to claim 12, wherein a source of the electronic program guide is a service that generates electronic program guide information available at a server accessible over the Internet.

16. The method according to claim 12, wherein the electronic program guide corresponds to content for a service or device different from a source of content currently being presented on the primary screen.

17. The method according to claim 12, wherein the first content is dynamic content and the second content is static content requiring the navigational programming command.

18. The method according to claim 12, wherein the primary screen, an audio source, and the secondary screen are arranged in a vertically stacked arrangement such that a central axis of the primary screen bifurcates the audio source and the secondary screen.

19. The method according to claim 12, wherein a width of the primary screen is substantially the same as a width of the secondary screen.

20. The method according to claim 12, wherein the navigational programming command does not disrupt displaying of the first content on the primary screen.
